(19) United States
(12) Patent Application Publication
(10) Pub. No.: US 2014/0014665 A1
(43) Pub. Date: Jan. 16, 2014

(54) LNG RECEIVING STRUCTURE

(71) Applicants: Taku Kojima, Tokyo (JP); Masahito Yamaguchi, Tokyo (JP)

(72) Inventors: Taku Kojima, Tokyo (JP); Masahito Yamaguchi, Tokyo (JP)

(21) Appl. No.: 14/008,180

(22) PCT Filed: Apr. 4, 2012
(86) PCT No.: PCT/JP2012/059211

§ 371 Date: Sep. 27, 2013

(30) Foreign Application Priority Data
Apr. 4, 2011 (JP) 2011-082770

(51) Int. Cl. F17C 3/00

(52) U.S. Cl. CPC F17C 3/00
USPC 220/565

(57) ABSTRACT

An LNG receiving structure of the present invention is provided with a leader pipe (1) that is placed underneath a receiving pipe (102) that penetrates a roof of an LNG tank, and that extends to a bottom end of the LNG tank. This LNG receiving structure employs a structure in which the cross-sectional area of the leader pipe is set greater than the cross-sectional area of the receiving pipe. According to this LNG receiving structure, it is possible to minimize the risk that rollover will occur when a plurality of types of LNG that each have mutually different densities are accumulated in the same LNG tank. It is also possible to suppress remixing of the gas when the LNG is received into the LNG tank.

### FIELD OF THE INVENTION

The present invention relates to an LNG (Liquefied Natural Gas) receiving structure.

Priority is claimed on Japanese Patent Application No. 2011-82770, filed Apr. 4, 2011, the contents of which are incorporated herein by reference.

### BACKGROUND ART

The composition, density (weight), and physical properties and the like of LNG differ depending on its place of production and on how it is handled. In recent years, in conjunction with the increasing demand for LNG, a need has arisen for a plurality of types of LNG having different densities to be received in the same LNG tank. Because of this, advances have been made in the development of technology for storing mixtures of different types of LNG While this technology for storing mixtures of different types of LNG has the considerable economic merit of facilitating the handling and distribution of LNG and also reducing equipment costs, there is, however, a need to construct measures to counter rollover which occurs as a result of stratification inside the LNG tank.

Stratification refers to a phenomenon in which, when a plurality of types of LNG that each have a different density are introduced into an LNG tank, the LNG having the greatest density (i.e., the heaviest LNG) accumulates at the bottom, while the LNG having the smallest density (i.e., the lightest LNG) accumulates at the top so as to create a plurality of liquid layers that each have a different density. Rollover refers to a phenomenon in which, inside an LNG tank that has become stratified in the above-described manner, density differences between the upper and lower layers are reduced as a result of heat being introduced from the outside so as to eliminate layer boundaries. This allows the heat energy that had built up in the lower layer to be released in a rapid time in the form of an enormous quantity of BOG (Boil Off Gas) from the surface of that layer.

When a quantity of BOG that exceeds the processing capability of a BOG compressor is generated by this rollover, it is necessary to operate a safety valve and discharge the excess BOG to the outside of the tank. However, if the quantity of BOG that is generated exceeds even the excess BOG discharge capability of the safety valve, then there is a likelihood that this will lead to a rupturing of the tank. In order to avoid rollover being generated, it is necessary to as far as possible suppress stratification inside an LNG tank.

Conventionally, two receiving pipes are provided penetrating the roof of an LNG tank, and a leader pipe that extends to the bottom of the LNG tank is provided underneath one of the receiving pipes. While heavy LNG is received from the top portion of the tank via a receiving pipe, light LNG is received from the bottom portion of the tank via a receiving pipe and the leader pipe. As a result, the mixing together of different types of LNG is promoted and stratification is restricted.

Note that those wishing to learn more about the LNG receiving structure of a conventional LNG tank may refer to Patent documents 1 and 2 (see below).

### RELATED ART DOCUMENTS

### Patent Documents

[Patent Document 1] Japanese Patent Application, First Publication No. 63-135698
[Patent Document 2] Japanese Patent Application, First Publication No. 2000-281178

### DISCLOSURE OF THE INVENTION

### Problems to be Solved by the Invention

A hopper that receives LNG expelled from the bottom end of a receiving pipe is provided at the top end of the leader pipe. When heavy LNG has accumulated inside the LNG tank, if light LNG is then introduced through the leader pipe, it becomes difficult for the light LNG to be expelled from the bottom end of the leader pipe because of the difference between the densities of the two LNG, and there is a possibility that the light LNG will overflow from the hopper.

If the light LNG overflows from the hopper in this manner, then because the light LNG accumulates on top of the heavy LNG that had previously accumulated, stratification, which causes rollover, is produced. In other words, in a conventional LNG receiving structure, because the risk of rollover occurring still exists, if light LNG is introduced while heavy LNG is still accumulated inside the LNG tank, work needs to proceed extremely cautiously with due consideration given to the above-described risk.

The present invention was conceived in view of the above-described circumstances and it is an object thereof to suppress the risk that rollover will occur when a plurality of types of LNG that each have mutually different densities are accumulated in the same LNG tank.

### Means for Solving the Problems

In order to achieve the aforementioned object, the LNG receiving structure according to a first aspect of the present invention is provided with a leader pipe that is placed underneath a receiving pipe that penetrates a roof of an LNG tank, and that extends to a bottom end of the LNG tank. In addition, the cross-sectional area of the leader pipe is set greater than the cross-sectional area of the receiving pipe.

In the LNG receiving structure according to a second aspect of the present invention, in the above-described first aspect, the leader pipe is installed within a pump barrel erection structure. In this case, it is also possible for the cross-sectional configuration of the leader pipe to be set so as to match the cross-sectional configuration of an internal space inside the pump barrel erection structure.

In the LNG receiving structure according to a third aspect of the present invention, in the above-described first or second aspects, there are provided inside the leader pipe: a guide component that performs the roles of reducing the initial velocity of the LNG expelled from the receiving pipe and guiding the LNG to an inside wall of the leader pipe; and gas discharge ports that discharge gas that has risen up from the bottom of the leader pipe to the outside.

In the LNG receiving structure according to a fourth aspect of the present invention, in the above-described third aspect, the guide component is a V-shaped plate having an inverted V-shape, and the V-plate is installed such that an apex portion thereof faces an expulsion port of the receiving pipe, while a space portion on the inside of the V-plate communicates with the gas discharge ports.

In the LNG receiving structure according to a fifth aspect of the present invention, in the above-described third or fourth aspects, there are further provided exhaust pipes that communicate with the gas discharge ports and extend in an upward direction.

### Effects of the Invention

According to the LNG receiving structure of the present invention, even if light LNG is introduced via a leader pipe into the interior of an LNG tank while heavy LNG is still accumulated inside the LNG tank, it is possible to limit the light LNG from overflowing from the top end of the leader pipe. Namely, because it is difficult for stratification to occur as a result of the overflowing light liquid accumulating on the surface layer of the already accumulated heavy LNG the risk of rollover occurring as a result thereof is also suppressed.

### BRIEF DESCRIPTION OF THE DRAWINGS

FIG. 1A is a perspective view showing an LNG receiving structure according to a first embodiment.

FIG. 1B is a cross-sectional view taken along a line A-A in FIG. 1A of the LNG receiving structure according to the first embodiment.

FIG. 2A is an explanatory view relating to the operating effects of the LNG receiving structure according to the first embodiment.

FIG. 2B is an explanatory view relating to the operating effects of the LNG receiving structure according to the first embodiment.

FIG. 2C is an explanatory view relating to the operating effects of an LNG receiving structure LS according to the first embodiment.

FIG. 3A is a side view showing an overall image of an LNG receiving structure according to a second embodiment.

FIG. 3B is a cross-sectional view taken along a line B-B in FIG. 3A of the LNG receiving structure according to the second embodiment.

FIG. 3C is a cross-sectional view taken along a line C-C in FIG. 3B of the LNG receiving structure according to the second embodiment.

FIG. 4 is an explanatory view relating to the operating effects of the LNG receiving structure according to the second embodiment.

### EMBODIMENTS FOR CARRYING OUT THE INVENTION

Hereinafter, embodiments of the present invention will be described with reference made to the drawings.

### First Embodiment

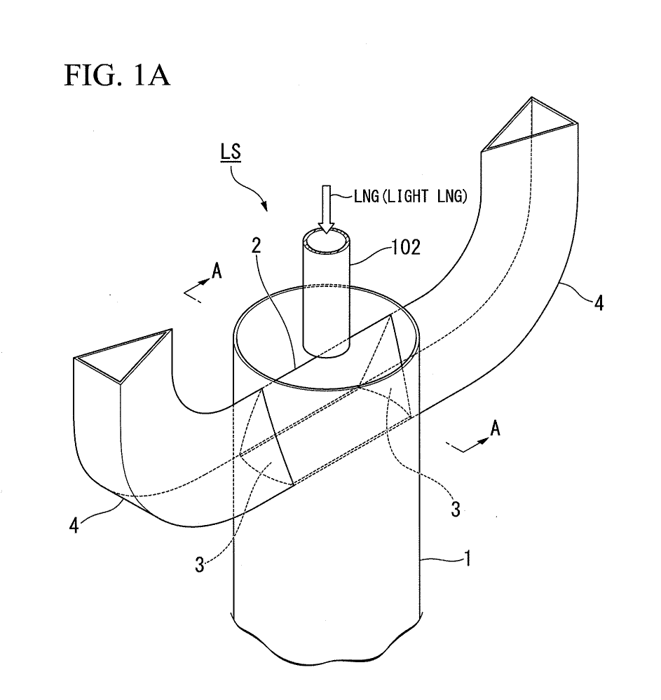

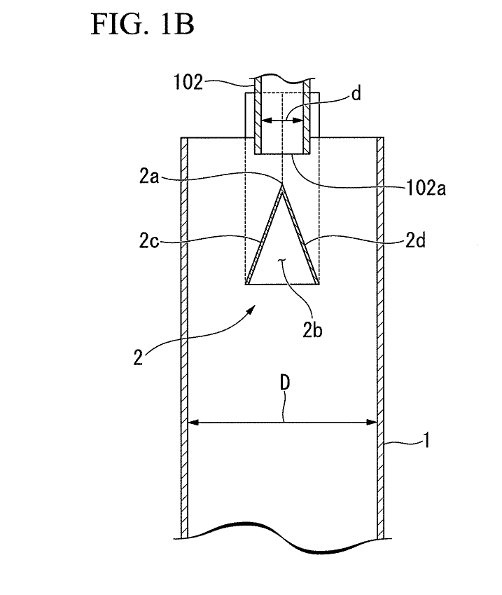

FIG. 1A is a perspective view of an LNG structure LS according to a first embodiment. FIG. 1B is a cross-sectional view taken along a line A-A in FIG. 1A of the LNG receiving structure LS.

In these drawings, the symbol 1 is a leader pipe that is placed below a receiving pipe 102 that penetrates a roof of an LNG tank, and that extends to a bottom end of the LNG tank. The symbol 2 is a guide component (i.e., a V-plate) that is provided inside the leader pipe 1, and that performs the roles of reducing the initial speed of the LNG that has been expelled from the receiving pipe 102 and guiding the LNG towards the inside wall of the leader pipe 1. The symbol 3 shows gas discharge ports that are provided in the leader pipe 1 and that discharge to the outside the gas that has risen up from the bottom of the leader pipe 1. The symbol 4 shows exhaust pipes that communicate with the gas discharge ports 3 and extend upwards.

The cross-sectional area of the leader pipe 1 is set larger than the cross-sectional area of the receiving pipe 102. Specifically, an aperture diameter D of the leader pipe 1 is set to between not less than 2.5 times and not more than 5 times an aperture diameter d of the receiving pipe 102. Namely, it is desirable for the cross-sectional area of the leader pipe 1 to be set to not less than 6.25 times and not more than 25 times the cross-sectional area of the receiving pipe 102.

More specifically, the aperture diameter D (i.e., the cross-sectional area) of the leader pipe 1 is set so as to satisfy the following conditions.
(1) If flash gas is mixed in with the LNG expelled from the receiving pipe 102, then this flash gas is separated out at the V-plate 2 inside the leader pipe 1 and also just before and just after it reaches the liquid surface. The flow of the flash gas below the V-plate 2 is then regulated inside the leader pipe 1 and the flash gas is discharged from inside the V-plate 2. As a result, foam from the flash gas inside the leader pipe 1 has a sufficient flow velocity to be able to rise upwards.
(2) A consistently stable liquid surface in which there is no disturbance to the gas-liquid flow is formed within the leader pipe 1 so that the distance from the liquid surface to the top end of the foam formation (i.e., the top end of the region where the gas phase and liquid phase become mingled together) can be shortened (i.e., the height to which the foam is formed can be lowered) (as a result of this, it becomes difficult for the LNG to overflow from the leader pipe 1).

The V-plate 2 has an inverted V shape and is installed such that an apex portion 2a of the V-plate 2 faces an expulsion port 102a of the receiving pipe 102, while a space portion 2b on the inside of the V-plate 2 (i.e., a space that is sandwiched between a pair of inclined portions 2c and 2d) communicates with the gas discharge ports 3.

Next, the operating effects of the LNG receiving structure LS that has the above-described structure will be described.

LNG unloaded from an LNG tanker is fed to an LNG tank via the receiving pipe 102 and the leader pipe 1. In many cases, this LNG is a gas/liquid mixture fluid body that, because of saturation vapor pressure, contains flash gas (hereinafter, this may be abbreviated to ‘gas’). The unloaded LNG is relatively light and if it contains flash gas, the light LNG that is expelled from the expulsion port 102a of the receiving pipe 102 collides with the V-plate 2, and the flow of the light LNG is divided into two with one portion flowing along the inclined portion 2c and the other portion flowing along the inclined portion 2d of the V-plate 2. The flows of the light LNG that have been divided by the V-plate 2 drop down respectively via the inside walls of the leader pipe 1.

In contrast, the flash gas that was mixed in with the light LNG expelled from the expulsion port 102a of the receiving pipe 102 collides with the V-plate 2 together with the light LNG, and the flow of the flash gas is divided into two with one portion flowing along the inclined portion 2c and the other portion flowing along the inclined portion 2d of the V-plate 2. As a result, the initial velocity thereof is reduced by the process of colliding with the leader pipe 1 and a portion of the flash gas is separated from the LNG

Moreover, in the process of the light LNG dropping down along the inside wall of the leader pipe 1, the light LNG forms a thin film (the same applies in the case of the heavy LNG), and the gas-liquid separation is further accelerated by the fact that the contact surface of the LNG with the gas is increased so that the gas is separated from the light LNG The separated gas rises up through the leader pipe 1 and reaches the space 2b on the inside of the V-plate 2. The gas that reaches the space 2b on the inside of the V-plate 2 is discharged to the outside through the exhaust pipes 4 from the discharge ports 3 that communicate with the space 2b.

In the present embodiment, because of the increases in the cross-sectional area and the inner circumferential surface area of the leader pipe 1, it is possible to achieve an improvement both in the flow velocity reduction of the LNG (i.e., the received liquid) containing flash gas that is flowing down through the leader pipe 1 from the receiving pipe 102 and in the separation and rising of the flash gas. It is also possible to achieve a rise in the separated flash gas and also to secure a flow path for the downwardly flowing received liquid, and to also achieve a reduction in the loss of pressure inside the leader pipe 1. Moreover, by suppressing rises in the velocity pressure and internal pressure of the inflowing liquid and the gas, it is possible to suppress an excessive penetration (i.e., reliquefaction) and remixing of the gas.

Moreover, it is also possible to improve the initial velocity reduction of the received liquid inside the leader pipe 1 by the V-plate 2, and to improve the separation of the flash gas from the received liquid that is achieved by guiding the received liquid to the inner circumferential surface of the leader pipe 1. It is also possible to regulate the flows of the rising flash gas after this has been separated and of the downwardly flowing received liquid, and to discharge the separated flash gas to the outside of the leader pipe 1 and also secure a flow path for the received liquid. Furthermore, by providing the exhaust pipes 4 which extend in an upwards direction, when the liquid surface inside the LNG tank reaches the gas discharge ports 3, it is possible to prevent the liquid intruding into the leader pipe 1 from the gas discharge ports 3 and causing the discharge of gas and the introduction of light LNG to be obstructed.

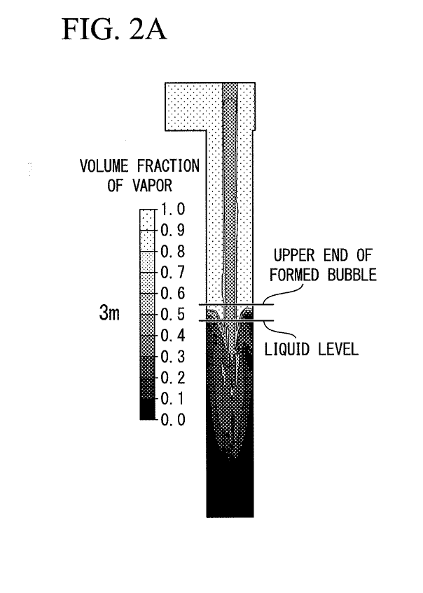

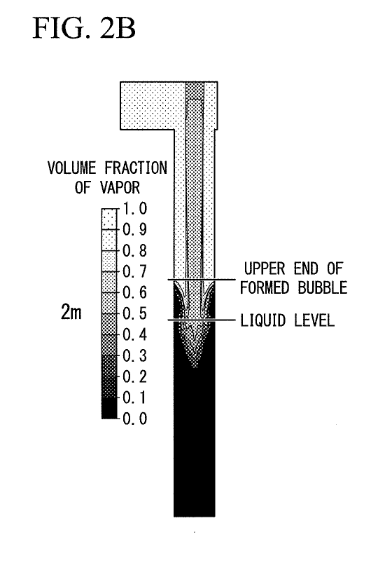

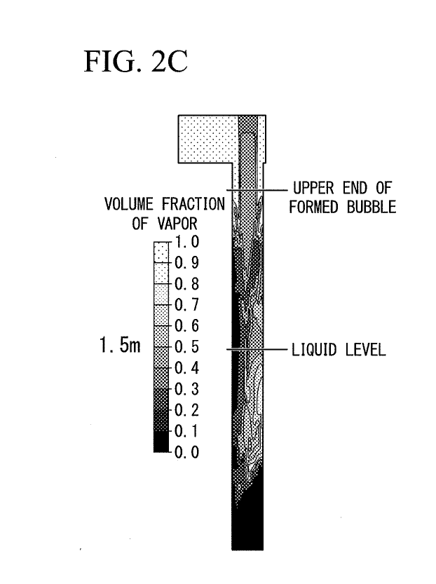

FIGS. 2A and 2B are distribution diagrams showing the volumetric steam quality when, as an example, the aperture diameter D of the leader pipe 1 is set to between not less than 2.5 times and not more than 5 times the aperture diameter d of the receiving pipe 102, with FIG. 2A showing a case when this is translated to an actual machine so that D=3 m, and FIG. 2B showing a case when this is translated to an actual machine so that D=2 m. Moreover, FIG. 2C is a distribution diagram showing the volumetric steam quality inside the leader pipe 1 when the aperture diameter D of the leader pipe 1 is set to twice the aperture diameter d of the receiving pipe 102 (i.e., D=1.5 m when this is translated to an actual machine).

As is shown in these drawings, when the aperture diameter D of the leader pipe 1 is set to between 5 times and 2.5 times the aperture diameter d of the receiving pipe 102, it can be seen that a consistently stable liquid surface is formed, and the distance from the liquid surface to the top end of the foam formation is shortened (i.e., the height to which the foam is formed is lowered) (namely, it is difficult for the LNG to overflow from the leader pipe 1). In contrast, if the diameter aperture D of the leader pipe 1 is set to twice the aperture diameter d of the receiving pipe 102, then it can be seen that an unstable liquid surface is formed, and the distance from the liquid surface to the top end of the foam formation is lengthened (i.e., the height to which the foam is formed is raised) (namely, it is easy for LNG to overflow from the leader pipe 1).

Therefore, according to the present embodiment, when heavy LNG has accumulated inside an LNG tank, even if light LNG is introduced into the LNG tank through the leader pipe 1, it is difficult for the light LNG to overflow from the top end of the leader pipe 1, namely, it is difficult for stratification that is caused by overflowing light liquid accumulating on the surface of heavy LNG to occur. As a result, it is possible to suppress the risk that rollover will occur as a result of such stratification.

### Second Embodiment

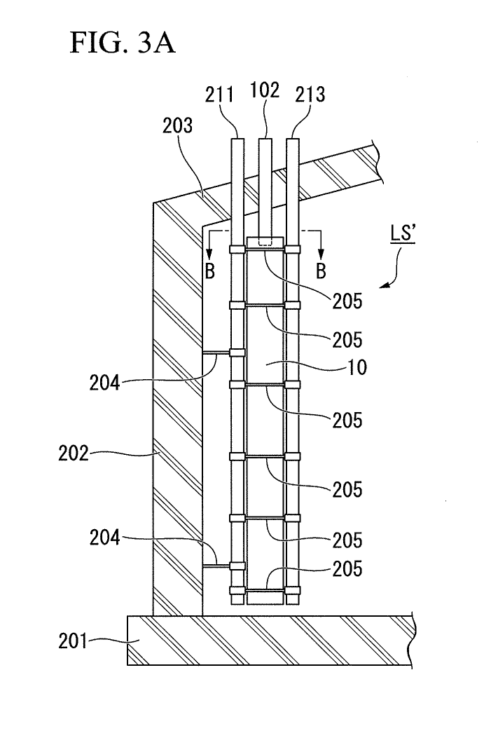

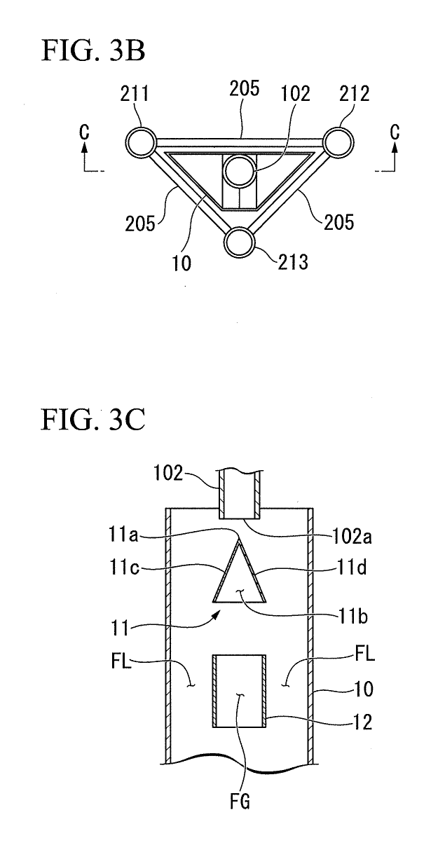

Next, a second embodiment of the present invention will be described. FIG. 3A is a side view showing an image of an entire LNG receiving structure LS′ of the second embodiment. FIG. 3B is a cross-sectional view taken along a line B-B in FIG. 3A. FIG. 3C is a cross-sectional view taken along a line C-C in FIG. 3B.

In FIG. 3A, the symbol 201 shows a bottom end plate of an LNG tank. The symbol 202 is a circular cylinder-shaped side wall that is fitted vertically onto the top surface of the bottom end plate 201, and the symbol 203 is a dome-shaped roof that is positioned so as to block off the top aperture.

As is shown in FIGS. 3A and 3B, pump barrels 211, 212, and 213 that penetrate the roof 203 and extend along the side wall 202 as far as the bottom end portion of the LNG tank (namely, the bottom end plate 201) may be installed inside the LNG tank. Specifically, of the pump barrels 211, 212, and 213, the pump barrels 211 and 212 are fixed via supporting components 204 to the side wall 202, and the pump barrels 211, 212, and 213 are mutually connected together via fixing components 205 so as to form a triangular shape when seen in plan view.

The pump barrels 211, 212, and 213 are pipes that are provided in order to remove (i.e., transport) LNG that has been suctioned by a sendout pump (not shown) located inside the LNG tank to the outside of the LNG tank. Generally, as is shown in FIGS. 3A and 3B, the three pumps 211, 212, and 213 are mutually interconnected, and form a single pump barrel erection structure. Note that in FIGS. 3A and 3B, in order to simplify the explanation, only one pump barrel erection structure is shown, however, it is also possible for a plurality of pump barrel erection structures to be provided in accordance with the scale of the LNG tank and the number of sendout pumps that have been installed.

Moreover, a leader pipe 10 of the present embodiment is placed below the receiving pipe 102 that penetrates the roof 203 of the LNG tank, and is positioned such that it extends to the bottom end portion of the LNG tank through the middle of the pump barrel erection structure.

Specifically, as is shown in FIG. 3B, because the cross-sectional configuration of the pump barrel erection structure that is formed by the pump barrels 211, 212, and 213 is triangular, the cross-sectional configuration of the leader pipe 10 is formed as a trapezoidal shape (it may also be triangular) so as to match the cross-sectional configuration of the internal space within the pump barrel erection structure. Furthermore, the cross-sectional area of the leader pipe 10 is made as much as possible the same as the cross-sectional area of the pump barrel erection structure (insofar as it does not into contact with the components of the pump barrel erection structure) so that the cross-sectional area of the pump barrel erection structure, namely, the internal space thereof can be used effectively.

Note that, although omitted from FIGS. 3A and 3B, the leader pipe 10 is fixed to and supported by the pump barrels 211, 212, and 213 via leader pipe fixing components (not shown) so as to extend through the interior of the pump barrel erection structure as far as the bottom end portion of the LNG tank.

Moreover, as is shown in FIG. 3C, inside the leader pipe 10 are provided a guide component 11 that performs the roles of reducing the initial velocity of the LNG expelled from the receiving pipe 102 and guiding the LNG to the inside wall of the leader pipe 10, and a partitioning component 12 that partitions the internal space inside the leader pipe 10 into an LNG flow path FL and a gas flow path FG Furthermore, although omitted from FIGS. 3A through 3C, in the same way as in the first embodiment, gas discharge ports that discharge gas that has risen upwards from the bottom of the leader pipe 10 to the outside are provided in the wall surface of the leader pipe 10.

The guide component 11 is a V-plate having an inverted V shape and is installed such that an apex portion 11a thereof faces the expulsion port 102a of the receiving pipe 102, while a space portion 11b on the inside of the guide component 11 (i.e., a space that is sandwiched between a pair of inclined portions 11c and 11d) communicates with gas discharge ports (not shown).

The partitioning component 12 is a cylindrical component that forms a space between its own outside wall and the inside wall of the leader pipe 10 as the LNG flow path FL, and forms its own internal space as the gas flow path FG. Note that in FIG. 3C, a state is shown in which only one partitioning component 12 is provided inside the leader pipe 10, however, it is also possible for a plurality of partitioning components 12 to be placed at equal intervals in the lengthwise direction of the leader pipe 10. Moreover, if necessary, in the same way as in the first embodiment, it is also possible to provide exhaust pipes 4 that communicate with the gas discharge ports and extend in an upwards direction.

Next, the operating effects of the LNG receiving structure LS′ that has the above-described structure will be described.

In the same way as in the first embodiment, light LNG unloaded from an LNG tanker is fed to an LNG tank via the receiving pipe 102 and the leader pipe 10. This light LNG is a gas/liquid mixture fluid body that contains flash gas. The light LNG that is expelled from the expulsion port 102a of the receiving pipe 102 collides with the guide component 11 so that the initial velocity thereof is reduced. In addition, the flow of this light LNG is divided into two with one portion flowing along the inclined portion 11c of the guide component 11 and the other portion flowing along the inclined portion 11d of the guide component 11. The flows of the light LNG that have been divided by the guide component 11 drop down respectively via the inside walls of the leader pipe 10.

In the process of the light LNG dropping down along the guide component 11 and the inside wall of the leader pipe 10, the flow velocity of the light LNG is reduced so that the gas-liquid separation is accelerated and the gas is separated from the light LNG The separated gas rises up through the leader pipe 10, and reaches the space 11b on the inside of the guide component 11 via the gas flow path FG of the partitioning component 12. The gas that rises as far as the space 11b on the inside of the guide component 11 is discharged to the outside of the leader pipe 10 from the gas discharge ports that communicate with the space 11b.

Namely, by employing the LNG receiving structure LS′ of the second embodiment, it is possible to obtain the same types of effects as those obtained from the first embodiment (i.e., improvements both in the flow velocity reduction of the received liquid containing flash gas that is flowing down through the leader pipe 10 and in the separation and rising of the flash gas, as well as achieving a rise in the separated flash gas and also securing a flow path for the downwardly flowing received liquid, and also achieving a reduction in the loss of pressure inside the leader pipe 10, and also suppressing excessive penetration (i.e., reliquefaction) and remixing of the gas by suppressing rises in the velocity pressure and internal pressure of the inflowing liquid and gas).

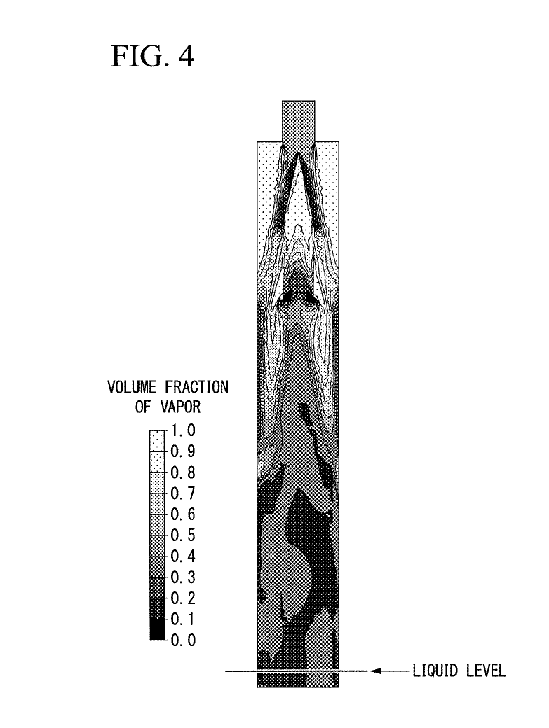

FIG. 4 is a distribution diagram showing the volumetric steam quality inside the leader pipe 10 when the leader pipe 10 is viewed from the direction shown in FIG. 3C. As is shown in this drawing, in the second embodiment as well, it can be seen that it is possible to: improve the separation of the flash gas by reducing the initial velocity of the received liquid inside the leader pipe 10 and guiding the received liquid to the inner circumferential surface of the leader pipe 10 by means of the guide component 11; and to regulate the rise of the separated flash gas and the flow of the downwardly flowing received liquid; and to discharge the separated flash gas to the outside of the leader pipe 10 and secure a reliable flow path for the received liquid.

As has been described above, according to the second embodiment, in the same way as in the first embodiment, when heavy LNG has accumulated inside an LNG tank, even if light LNG is introduced into the LNG tank through the leader pipe 10, it is difficult for the light LNG to overflow from the top end of the leader pipe 10, namely, it is difficult for stratification that is caused by overflowing light liquid accumulating on the surface of heavy LNG to occur. As a result, it is possible to suppress the risk that rollover will occur and to effectively utilize the internal space inside a pump barrel erection structure.

Note that the present invention is not limited to the above-described embodiments and various appropriate modifications can be made without departing from the spirit or scope of the present invention. For example, in the above-described first and second embodiments, cases in which a V-plate is used for the guide component 2 and the guide component 11 are described, however, a guide component of any desired shape may be used provided that it is able to perform the roles of reducing the initial velocity of the LNG expelled from the receiving pipe 102 and guiding the LNG to the inside wall of the leader pipe 1 or the leader pipe 10. Moreover, it is not absolutely essential for this guide component to be provided.

Moreover, in the above-described second embodiment, an example in which a pump barrel erection structure having a triangular cross-sectional configuration is described, however, the cross-sectional configuration of the pump barrel erection structure is not limited to this.

### INDUSTRIAL APPLICABILITY

According to the LNG receiving structure of the present invention, it is possible to minimize the risk that rollover will occur when a plurality of types of LNG that each have mutually different densities are accumulated in the same LNG tank.

### DESCRIPTION OF THE REFERENCE NUMERALS

LS, LS′ . . . LNG receiving structure, 1, 10 . . . Leader pipe, 2, 11 . . . V-plate (Guide component), 12 . . . Partitioning component, 3 . . . Gas discharge pipe, 4 . . . Exhaust pipe, 102 . . . Receiving pipe, 211, 212, 213 . . . Pump barrel

1. An LNG receiving structure that comprises a leader pipe that is placed underneath a receiving pipe that penetrates a roof of an LNG tank, and that extends to a bottom end of the LNG tank, wherein
the cross-sectional area of the leader pipe is set greater than the cross-sectional area of the receiving pipe.

2. The LNG receiving structure according to claim 1, wherein the leader pipe is installed within a pump barrel erection structure.

3. The LNG receiving structure according to claim 2, wherein the cross-sectional configuration of the leader pipe is set so as to match the cross-sectional configuration of an internal space inside the pump barrel erection structure.

4. The LNG receiving structure according to claim 1, wherein inside the leader pipe there are provided: a guide component that performs the roles of reducing the initial velocity of the LNG expelled from the receiving pipe and guiding the LNG to an inside wall of the leader pipe; and gas discharge ports that discharge gas that has risen up from the bottom of the leader pipe to the outside.

5. The LNG receiving structure according to claim 2, wherein inside the leader pipe there are provided: a guide component that performs the roles of reducing the initial velocity of the LNG expelled from the receiving pipe and guiding the LNG to an inside wall of the leader pipe; and gas discharge ports that discharge gas that has risen up from the bottom of the leader pipe to the outside.

6. The LNG receiving structure according to claim 4, wherein the guide component is a V-shaped plate having an inverted V-shape, and
the V-plate is installed such that an apex portion thereof faces an expulsion port of the receiving pipe, while a space portion on the inside of the V-plate communicates with the gas discharge ports.

7. The LNG receiving structure according to claim 5, wherein the guide component is a V-shaped plate having an inverted V-shape, and
the V-plate is installed such that an apex portion thereof faces an expulsion port of the receiving pipe, while a space portion on the inside of the V-plate communicates with the gas discharge ports.

8. The LNG receiving structure according to claim 4, wherein there are further provided exhaust pipes that communicate with the gas discharge ports and extend in an upward direction.

9. The LNG receiving structure according to claim 5, wherein there are further provided exhaust pipes that communicate with the gas discharge ports and extend in an upward direction.

10. The LNG receiving structure according to claim 6, wherein there are further provided exhaust pipes that communicate with the gas discharge ports and extend in an upward direction.

11. The LNG receiving structure according to claim 7, wherein there are further provided exhaust pipes that communicate with the gas discharge ports and extend in an upward direction.
